(19) United States
(12) Patent Application Publication
(10) Pub. No.: US 2014/0199572 A1
(43) Pub. Date: Jul. 17, 2014

(54) FILM-BASED BATTERY HOLDER

(71) Applicant: SENSORMATIC ELECTRONICS, LLC, Boca Raton, FL (US)

(72) Inventors: Justin STEWART, Deerfield Beach, FL (US); Timothy J. RELIHAN, Loxahatchee, FL (US)

(73) Assignee: SENSORMATIC ELECTRONICS, LLC, Boca Raton, FL (US)

(21) Appl. No.: 13/743,594

(22) Filed: Jan. 17, 2013

(51) Int. Cl. H01M 2/10

(52) U.S. Cl. CPC H01M 2/1038
USPC 429/99; 429/100; 429/96; 29/623.1

(57) ABSTRACT

A battery pack is provided. The battery pack includes a first battery that includes a first terminal and second terminal on the opposite side of the battery from the first terminal. The battery pack further includes a battery holder. The battery holder includes a flexible substrate and a first conductive element disposed on the flexible substrate. The first conductive element has a first contact region to electrically engage with the first terminal. The battery holder further includes a second conductive element that has a second contact region to electrically engage with the second terminal when the flexible substrate is folded over the first battery.

### STATEMENT REGARDING FEDERALLY SPONSORED RESEARCH OR DEVELOPMENT

n/a

### FIELD OF THE INVENTION

The present invention relates to battery holders, and in particular to flexible film-based battery holders.

### BACKGROUND OF THE INVENTION

The use of smaller electronic devices has continued to increase as consumers continue to demand device portability or smaller device footprints. In order to power these smaller electronic devices, low capacity coin or button cell batteries are typically used as the power source. For example, simple circuit devices such as a portable electronic article surveillance (EAS) hard tags, hearing aids or laser pointers use these coin batteries. Other more complex electronic devices also use coin cell batteries.

In order to provide a reliable contact point for the coin cell battery within the electronic device, a battery holder is required. One battery holder design is based on a stamped metal arrangement in which bent sheet metal is added to the design until proper contact constraints and dimensions to hold the battery have been established. The part is then soldered to a printed circuit board (PCB) and is ready to accept the battery. In another battery holder design, leads are directly attached to the battery and then soldered to the PCB. As another example, the battery holder may be made of molded plastic with metal contacts arranged thereon to contact the battery. The battery holder is then soldered onto the PCB via lead wires or metal connectors protruding from the battery holder, i.e., PCB mount battery holder. However, the cost associated with these types of battery holders typically matches or exceeds the cost associated with the battery itself. Put simply, these designs are not cost efficient.

### SUMMARY OF THE INVENTION

The present invention advantageously provides a method and device for holding a battery using a flexible substrate.

According to one embodiment, a battery holder for retaining a first battery having a first terminal and a second terminal on an opposite side of the battery from the first terminal is provided. The battery holder includes a flexible substrate and a first conductive element disposed on the flexible substrate. The first conductive element has a first contact region to electrically engage with the first terminal. The battery holder further includes a second conductive element that has a second contact region to electrically engage with the second terminal when the flexible substrate is folded over the first battery.

According to another embodiment, a battery pack is provided. The battery pack includes a first battery that includes a first terminal and second terminal on the opposite side of the battery from the first terminal. The battery pack further includes a battery holder. The battery holder includes a flexible substrate and a first conductive element disposed on the flexible substrate. The first conductive element has a first contact region to electrically engage with the first terminal. The battery holder further includes a second conductive element that has a second contact region to electrically engage with the second terminal when the flexible substrate is folded over the first battery.

According to another embodiment, a method of assembling a battery pack from a flexible substrate that includes at least a first conductive element that has a first contact region and second conductive element that has a second contact region is provided. A first battery that has a first terminal and second terminal is positioned on the first contact region. The first terminal electrically engages the first contact region. A portion of the flexible substrate that includes the second conductive element is folded over the first battery to electrically engage the second terminal with the second conductive element.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of an exemplary battery holder system constructed in accordance with the principles of present invention;

FIG. 2 is another perspective view of the system of FIG. 1 constructed in accordance with the principles of the present invention;

FIG. 3 is another perspective view of the system of FIG. 1 constructed in accordance with the principles of the present invention;

FIG. 4 is a perspective view of an electronic surveillance tag incorporating the battery pack of FIG. 1 constructed in accordance with the principles of the present invention;

FIG. 5 is a perspective view of another battery holder system constructed in accordance with the principles of the present invention;

FIG. 6 is another perspective view of the system of FIG. 5 constructed in accordance with the principles of the present invention;

FIG. 7 is another perspective view of the system of FIG. 5 constructed in accordance with the principles of the present invention;

FIG. 8 is another perspective view of the system of FIG. 5 constructed in accordance with the principles of the present invention; and

FIG. 9 is a flow chart of an exemplary process for assembly of a battery pack in accordance with the principles of the present invention.

### DETAILED DESCRIPTION OF THE INVENTION

The present invention advantageously provides an apparatus, system and method for a battery holder and battery pack. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

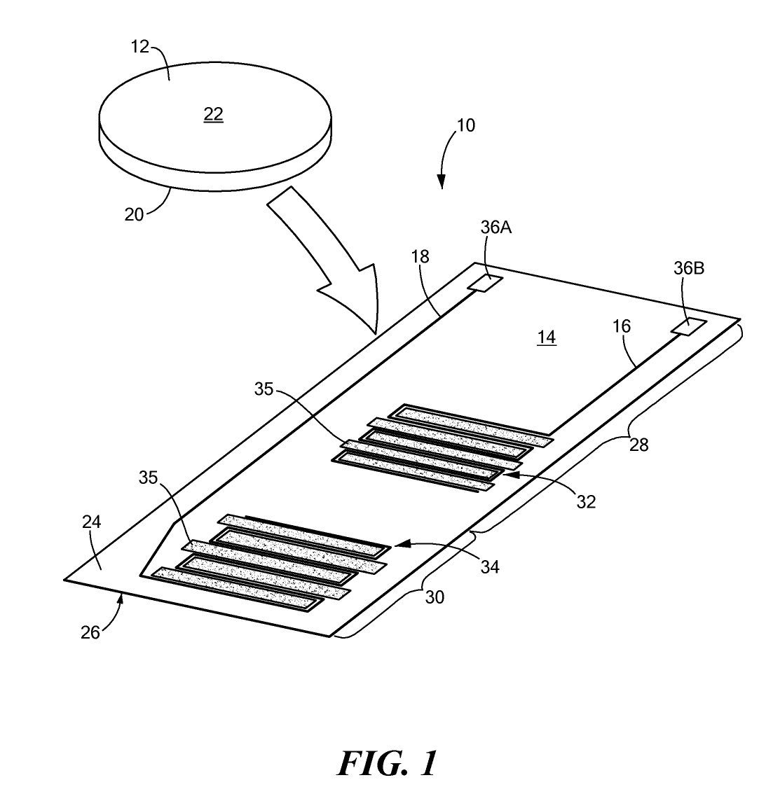

One embodiment of the present invention advantageously provides a battery holder system and method. Referring now to the drawing figures, in which like reference designators refer to like elements, there is shown in FIG. 1 a system constructed in accordance with the principles of the present invention and designated generally as “10.” System 10 includes battery 12, substrate 14, first conductive element 16 and second conductive element 18. Battery 12 may be a coin or button cell battery, among other battery types. Battery 12 includes first terminal 20 and second terminal 22 in which one of first terminal 18 and second terminal 22 is a positive terminal of battery 12 and the other one of first terminal 20 and second terminal 22 is a negative terminal of battery 12.

Substrate 14 is a flexible substrate that is constructed of a non-conductive film such as KAPTON or polyethylene terephthalate (PET) film, among other flexible non-conductive films. Substrate 14 includes primary side 24 and secondary side 26 opposite primary side 24. Substrate 14 further includes first portion 28 and second portion 30 in which one of first portion 28 and second portion 30 is arranged to fold over the other portion of substrate 14, as discussed in detail with respect to FIG. 3.

First conductive element 16 is a conductive trace disposed on first portion 28 and primary side 24 of substrate 14. First conductive element 16 includes first conductive region 32 on which battery 12 may be disposed. First conductive region 32 is arranged to electrically engage battery 12, i.e., first terminal 20 or second terminal 22 of battery 12. First contact region 32 is formed by a portion of first conductive element 16 in which the portion of first conductive element 16 is disposed on substrate 14 in a pattern and/or or non-pattern layout.

Second conductive element 18 is a conductive trace disposed on first portion 28, second portion 30 and primary side 24 of substrate 14 in which second conductive element 18 is electrically isolated from first conductive element 16. Second conductive element 18 includes second contact region 34 arranged to electrically engage battery 12, i.e., electrically engage the other battery terminal not electrically engaged to first contact region 32, when second portion 30 of substrate 14 is folded over first portion 28 of substrate 14. Alternatively, first portion 28 may be folded over second portion 30. Second contact region 34 is formed by a portion of second conductive element 18 disposed on substrate 14 in a pattern or non-pattern layout. First conductive element 16 and second conductive element 18 further include respective device contact points 36a and 36b (collectively referred to as “device contact point 36”) that provide an area or point where an electronic device, such as an EAS tag, may electrically engage system 10. The device contact point 36 may be metal grommet (FIGS. 6-8).

First conductive element 16 and/or second conductive element 18 may be formed by conductive ink in which adhesive 35 is disposed adjacent to or in between the conductive ink pattern to secure or retain battery 12 to substrate 14, i.e., helps keep first conductive region 32 and second conductive region 34 electrically engaged to battery 12. In another embodiment, conductive epoxy may be used in which the conductive epoxy secures battery 12 to substrate 14 while electrically engaging battery 12. Alternatively, first conductive element 16 and/or second conductive element 18 may be formed from other conductive materials that electrically engage terminals 20 and 22, adhere to substrate 14 and flex such that substrate 14 may be folded around a portion of battery 12.

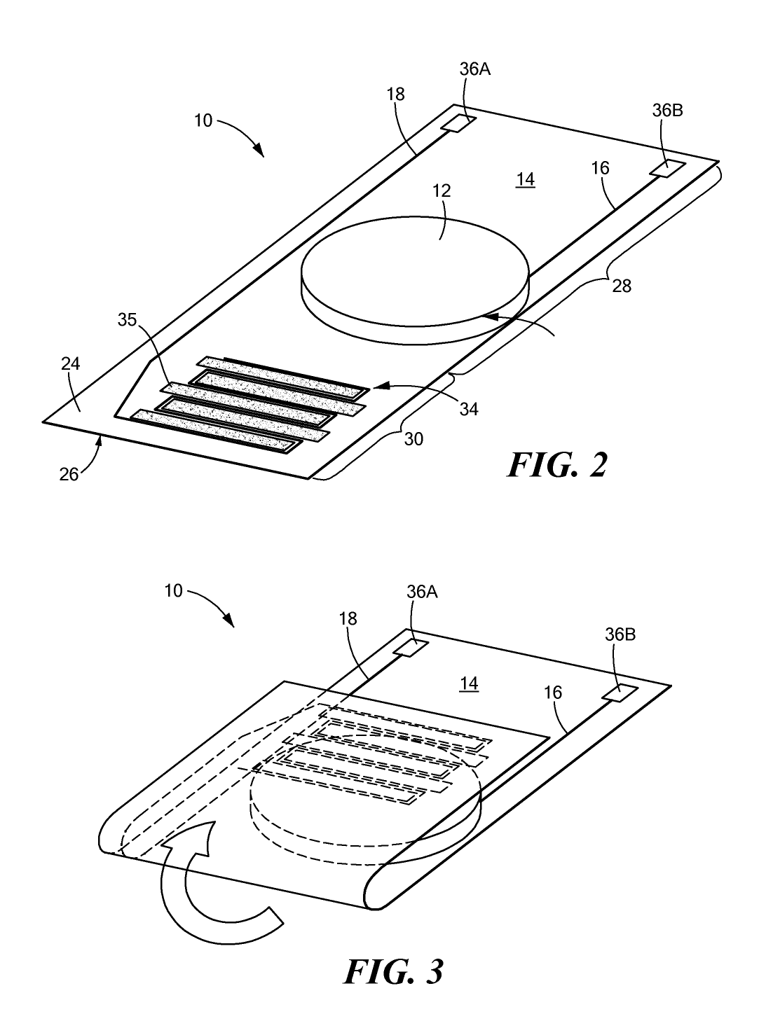

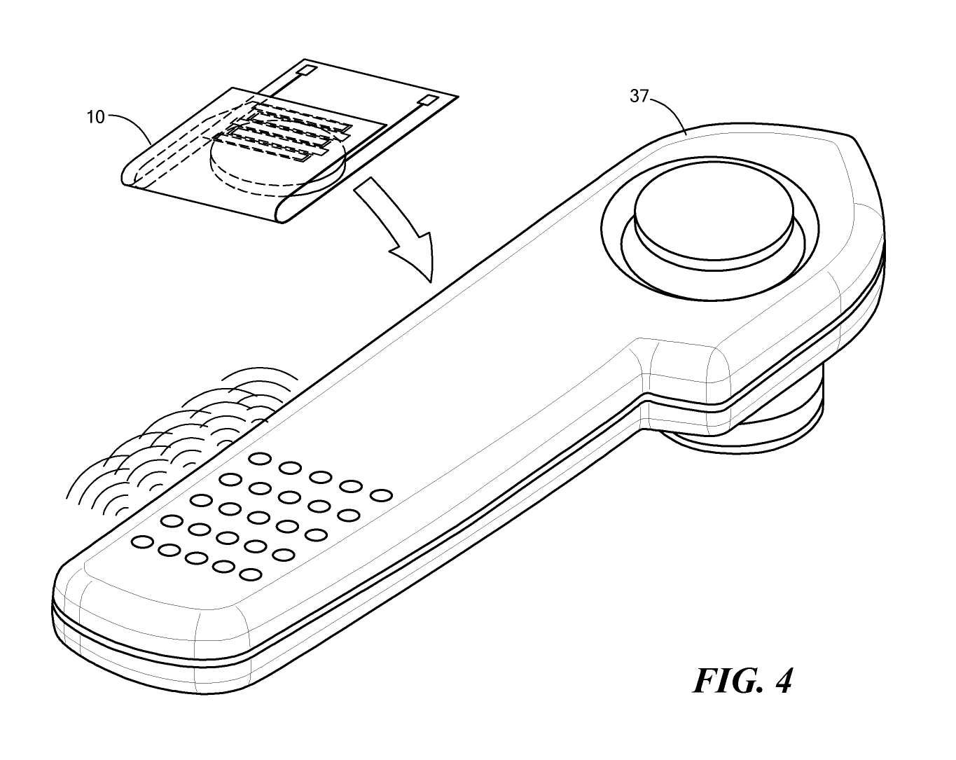

FIGS. 2-3 illustrate system 10 at different stages of assembly. In particular, battery 12 is positioned on first contact region 32 (FIG. 2) such that first terminal of battery 12 electrically engages first contact region 32. Second portion 30 of substrate 14 is folded over at least a portion of battery 12 and first portion 32 such that second contact region 34 electrically engages battery 12, i.e., electrically engages second terminal 22 (FIG. 3). Referring to FIG. 4, electronic article surveillance (EAS) tag 37 is illustrated. In particular, EAS tag 37 is an active tag that uses power supplied by system 10, i.e., battery pack, to communicate with an EAS interrogation system and/or actuate an audible alarm. Non-contact portions of traces can be coated with insulating substance(s), e.g., non-conductive epoxy, to help prevent short circuits.

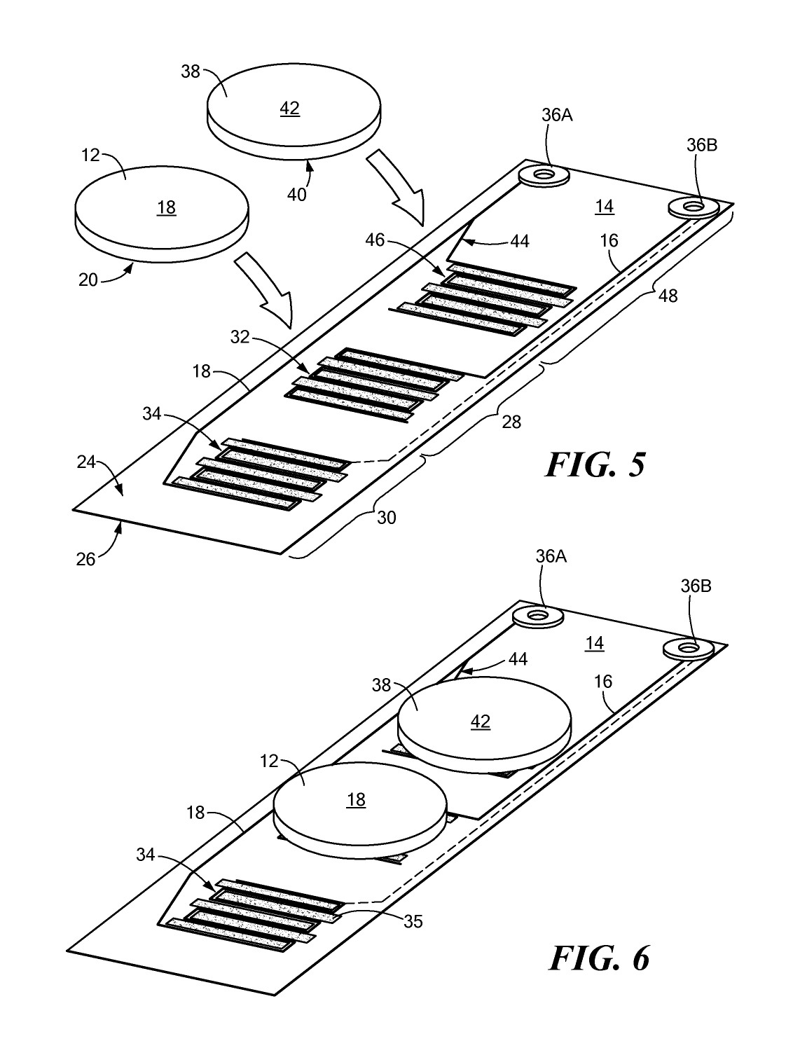

FIG. 5 illustrates an alternative embodiment of system 10 that is arranged to electrically engage two batteries 12 and 38. System 10 includes battery 12 and battery 38 in which battery 38 includes third terminal 40 and fourth terminal 42. Substrate 14 includes first portion 28 having first contact region 32 and second portion 30 having second contact region 34, as described above with respect to FIGS. 1-3. Substrate 14 further includes third conductive element 44 having third contact region 46 disposed on third portion 48 and primary side 24 of substrate 14. In particular, third contact region 46 is formed by a portion of third conductive element 44 disposed on substrate 14 in a pattern and/or non-pattern layout. Further, third conductive element 44 may be connected to device contact point 36 via second conductive element 18 or may be connected directly to device contact point 36. Third contact region is arranged to electrically engage one of third terminal 40 and fourth terminal 42 when battery 38 is disposed on third contact region 46.

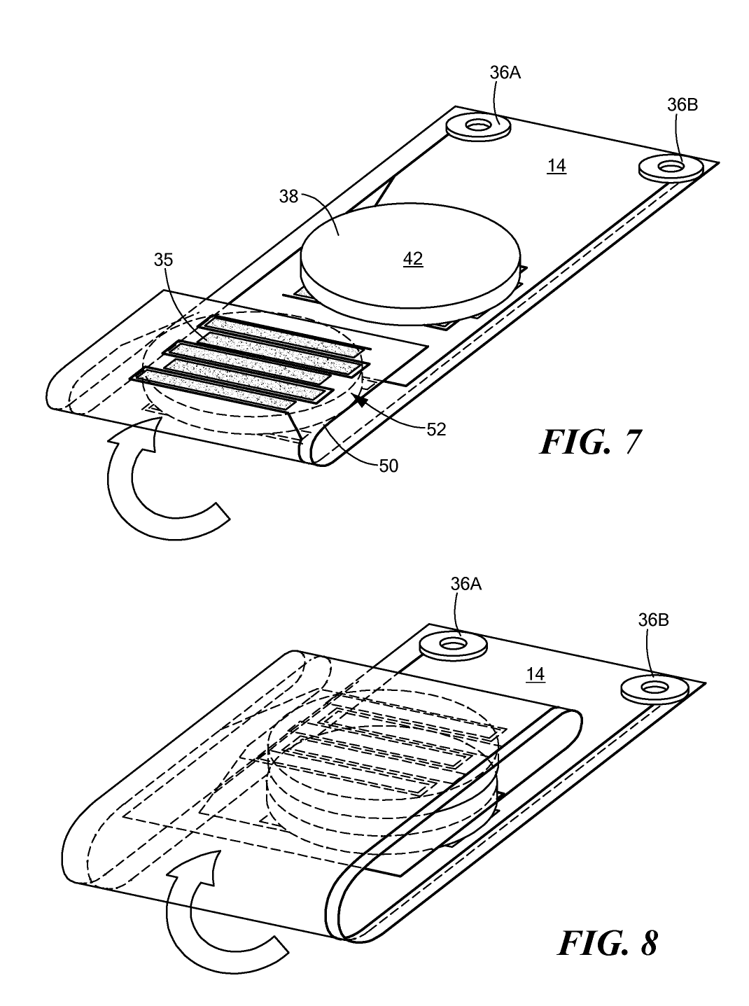

Substrate 14 further includes forth conductive element 50 (FIG. 7) disposed on secondary side 26 of substrate 14. Fourth conductive element 50 includes fourth contact region 52 (FIG. 7) disposed on second portion 30 and secondary side 26 of substrate 14. Fourth contact region 52 is formed by a portion of fourth conductive element 50 disposed on substrate 14 in a pattern and/or non-pattern layout. Fourth conductive element 50 is electrically connected to first conductive element 16 via device contract point 36, i.e., metal grommet. Adhesive 35 is disposed adjacent to or in between first, second, third and fourth conductive elements 16, 18, 44 and 50, i.e., next to conductive ink traces, such that batteries 12 and 38 are secured to substrate 14 in order to help keep batteries 12 and 38 electrically engaged with respective contact regions. Alternatively, the conductive elements may be formed using conductive epoxy, thereby eliminating the need for adhesive 35. The embodiment of FIG. 5 is not limited to two batteries in which additional conductive elements may be added to a longer substrate such that more batteries may be accommodated. Moreover, first, second, third, fourth and/or additional conductive elements may be arranged to form a different electrical circuit than illustrated in FIG. 5 depending on whether batteries 12 and 38 need to be in an electrical series and/or parallel connection to each other.

FIGS. 5-8 illustrate different stages during production of this embodiment of system 10. Batteries 12 and 38 are disposed on first contact region 32 and third contact region 46, respectively. First contact region 32 electrically engages first terminal 20 while third contact region 46 electrically engages third terminal 40. Second portion 30 is folded over at least a portion of battery 12 and/or first portion 28, as discussed above with respect to FIGS. 2-3. First and second portions 28 and 30 of substrate 14 are then folded around at least a portion of second battery 38 and/or third portion 48 such that fourth contact region 52 is electrically engaged to fourth terminal 42 of second battery 38.

The invention provides a battery holder and battery pack that can be mass produced and cut to the appropriate size. The battery holder also allows for different size coin cell batteries to be used with the same battery holder as the placement of contact regions on substrate 14 does not require an exact coin size battery, thereby allowing various types of coin batteries to be accommodated. Since the battery holder is not made of sheet metal, the battery holder, i.e., substrate 14, is less susceptible to corrosion, limits static discharge, weighs less and requires less space. Furthermore, when system 10 is assembled, as illustrated in FIGS. 3 and 8, exposure of conductive elements (16, 18, 44 and 50) and contact regions are substantially reduced or eliminated such that electrical components that come into contact with the film are not electrically charged by batteries 12 and 38.

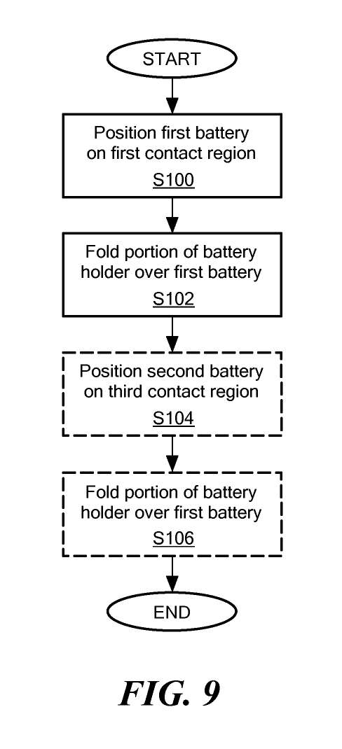

FIG. 9 is a flowchart of an exemplary process for assembling a battery pack having a flexible substrate including at least a first conductive element 16 including first contact region 32 and second conductive element 18 including a second contact region 34. A first battery is positioned on a first contact region of battery holder, i.e., substrate 14 (Block S100). For example, battery 12 is positioned on first contact region 32 or second contact region 34. A portion of the battery holder, i.e., flexible substrate 14, is folded over at least a portion of the first battery (Block S102). For example, second portion 30 may be folded over at least a portion of battery 12 and first portion 28, as illustrated in FIGS. 3 and 6, such that second contact region 34 electrically engages battery 12. A second battery is positioned on a third contact region of battery holder, i.e., substrate 14 (Block S104). In one embodiment, battery 38 is positioned on third contact region 48 such that third contact region 46 electrically engages battery 38, as illustrated in FIGS. 6-7. First and second portions of the battery holder, i.e., flexible substrate 14, are folded over the first battery (Block S106). For example, as illustrated in FIG. 7, first portion 28 and second portion 30 are folded over battery 38 and third portion 48 such that fourth contact region 52 electrically engages battery 38. Alternatively, Blocks S104 and S106 may be skipped based on design need such as if the battery holder of FIGS. 1-3 is being assembled. Also, Blocks S102 and S104 may be swapped such that the second battery is positioned on the flexible substrate before the second portion of the battery holder is folded over the first battery.

System 10 may also be arranged to hold cylindrical shaped batteries, among other battery types known in the art. System 10 provides an easy to replace battery that lowers cost because system 10 can directly contact the PCB of a device without an expensive on-board metal or combination plastic/metal battery holder. The time and cost associated with soldering the battery holder to the PCB is also eliminated. Further, system 10 does not require biasing elements, e.g., springs, to hold the battery in place against battery holder contact terminals to ensure proper contact since conductive epoxy and/or adhesive is used, thereby reducing manufacturing cost and complexity. Also, system 10 may be removably insertable within the electronic device (FIG. 4), thereby providing an easily replaceable battery pack. For example, substrate 14 and battery 12, i.e., battery holder and battery, may be provided as a single unit, e.g., to a retailer, such that a consumer can purchase the battery pack at the retailer to replace an existing battery within the consumer's electronic device. Retailers can also easily use the battery pack for replacement of dead batteries in active EAS tags.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A battery holder for retaining a first battery having a first terminal and a second terminal on an opposite side of the battery from the first terminal, the battery holder comprising:
a flexible substrate;
a first conductive element disposed on the flexible substrate, the first conductive element having a first contact region to electrically engage with the first terminal; and
a second conductive element having a second contact region to electrically engage with the second terminal when the flexible substrate is folded over the first battery.

2. The battery holder of claim 1, wherein the first conductive element and second conductive element are formed of conductive ink; and
the battery holder further includes an adhesive disposed adjacent to the first trace and second trace.

3. The battery holder of claim 1, wherein the first conductive element is electrically isolated from the second conductive element.

4. The battery holder of claim 1, wherein the battery holder is further configured retain a second battery having a third terminal and fourth terminal;
the battery holder further comprising:
a third conductive element disposed on the flexible substrate, the third conductive element having a third contact region to electrically engage the third terminal.

5. The battery holder of claim 4, wherein the third conductive element is disposed on the same side of the flexible substrate as the first conductive element.

6. The battery holder of claim 4, further comprising a fourth conductive element disposed on the flexible substrate, the fourth conductive element having a fourth contact region to electrically engage the fourth terminal.

7. The battery holder of claim 6, wherein the first conductive element is electrically connected to the fourth conductive element; and
the third conductive element is electrically connected to the second conductive element.

8. The battery holder of claim 6, wherein the flexible substrate has a first side and a second side opposite the first side, the first, second and third conductive elements being disposed on the first side, the fourth conductive element being disposed the second side.

9. The battery holder of claim 1, wherein the first conductive element and second conductive element are formed of conductive epoxy.

10. The battery holder of claim 1, wherein the first conductive element is electrically isolated from the second conductive element.

11. The battery holder of claim 1, wherein the first conductive element includes a first metal grommet distal the first contact region; and
the second conductive element includes a second metal grommet distal the second contact region.

12. A battery pack, comprising:
a first battery, the first battery including a first terminal and second terminal on the opposite side of the battery from the first terminal;
a battery holder, the battery holder including:
a flexible substrate;
a first conductive element disposed on the flexible substrate, the first conductive element having a first contact region to electrically engage with the first terminal; and
a second conductive element having a second contact region to electrically engage with the second terminal when the flexible substrate is folded over the first battery.

13. The battery pack of claim 12, wherein the first conductive element and second conductive element are formed of conductive ink; and
the battery holder further includes an adhesive disposed adjacent to the first trace and second trace.

14. The battery pack of claim 12, wherein the first conductive element is electrically isolated from the second conductive element.

15. The battery pack of claim 12, wherein the battery holder is further configured retain a second battery having a third terminal and fourth terminal;
the battery holder further comprising:
a third conductive element disposed on the flexible substrate, the third conductive element having a third contact region to electrically engage one of the third terminal and fourth terminal.

16. The battery pack of claim 15, further comprising a fourth conductive element disposed on the flexible substrate, the fourth conductive element having a fourth contact region to electrically engage one of the third terminal and fourth terminal.

17. The battery pack of claim 16, wherein the flexible substrate has a first side and a second side opposite the first side, the first, second and third conductive elements being disposed on the first side, the fourth conductive element being disposed on the second side.

18. The battery pack of claim 12, wherein the first conductive element and second conductive element are formed of conductive epoxy.

19. A method of assembling a battery pack from a flexible substrate including at least a first conductive element having a first contact region and second conductive element having a second contact region, the method comprising:
positioning a first battery having a first terminal and second terminal on the first contact region, the first terminal electrically engaging the first contact region; and
folding a portion of the flexible substrate including the second conductive element over the first battery to electrically engage the second terminal with the second conductive element.

20. The method of claim 19, wherein the flexible substrate includes a third conductive element having a third contact region and fourth conductive element having a fourth contact region; and
the method further includes:
positioning a second battery having a third terminal and fourth terminal on the third contact region, the third terminal electrically engaging the third contact region;
folding another portion of the flexible substrate including the first, second and fourth contact regions over the second battery to electrically engage the fourth terminal with the fourth contact region.
